(19) United States
(12) Patent Application Publication
(10) Pub. No.: US 2018/0034027 A1
(43) Pub. Date: Feb. 1, 2018

(54) COMPOSITE SEPARATOR, METHOD FOR MAKING THE SAME, AND LITHIUM ION BATTERY USING THE SAME

(71) Applicants: Jiangsu Huadong Institute of Li-Ion Battery Co., Ltd., Suzhou (CN); Tsinghua University, Beijing (CN)

(72) Inventors: YU-MING SHANG, Beijing (CN); XIANG-MING HE, Beijing (CN); LI WANG, Beijing (CN); YAO-WU WANG, Beijing (CN); JIAN-JUN LI, Beijing (CN); JIAN GAO, Beijing (CN)

(73) Assignees: Jiangsu Huadong Institute of Li-Ion Battery Co., Ltd., Suzhou (CN); Tsinghua University, Beijing (CN)

(21) Appl. No.: 15/729,683

(22) Filed: Oct. 11, 2017

Related U.S. Application Data
(63) Continuation of application No. PCT/CN2016/077908, filed on Mar. 30, 2016.

(30) Foreign Application Priority Data
Apr. 13, 2015 (CN) 201510173004.4

(51) Int. Cl. H01M 2/16; H01M 2/14; H01M 10/0565; H01M 10/0525

(52) U.S. Cl. CPC H01M 2/162; H01M 10/0525; H01M 2/145; H01M 10/0565

(57) ABSTRACT

A composite separator comprises a non-woven fabric-polymer composite separator substrate and a composite gel combined with the non-woven fabric-polymer composite separator substrate. The composite gel comprises a gel polymer and a nano-barium sulfate whose surface is modified with lithium carboxylate group. The nano-barium sulfate is dispersed to the gel polymer. The non-woven fabric-polymer composite separator substrate comprises a non-woven fabric and a soluble heat-resistant polymer. A method for making the composite separator and a lithium ion battery comprising the composite separator are also disclosed in the present disclosure.

### CROSS-REFERENCE TO RELATED APPLICATIONS

This application claims all benefits accruing under 35 U.S.C. §119 from China Patent Application No. 201510173004.4, filed on Apr. 13, 2015 in the State Intellectual Property Office of China, the content of which is hereby incorporated by reference. This application is a continuation under 35 U.S.C. §120 of international patent application PCT/CN2016/077908 filed on Mar. 30, 2016, the content of which is also hereby incorporated by reference.

### FIELD

The present disclosure relates to a composite separator, a method for making the composite separator, and a lithium ion battery using the composite separator.

### BACKGROUND

In a lithium ion battery, some features of a conventional polyolefin separator, such as thermo stability and puncture resistance to lithium dendrite, are difficult to meet the strict requirements of new generation storage batteries or power batteries. The polyolefin separator is usually obtained by dry or wet pore-forming and stretching. A serious thermal contraction of the polyolefin separator can occur once the lithium ion battery is overheated, which can cause collapse of the polyolefin separator, and short-circuit and cause a thermo runaway of the lithium ion battery. A nano-fiber non-woven fabric separator has high porosity (larger than 80%) and can be made with heat-resistant materials (such as polyimide, polyethylene terephthalate, nylon, glass fiber, etc.) without stretching. Therefore, no thermal contraction is generated even when the nano-fiber non-woven fabric separator is heated to a temperature above 200° C. The nano-fiber non-woven fabric separator has been considered for separator materials of the new generation storage batteries or power batteries. However, the nano-fiber non-woven fabric separator cannot be used independently as the separator of the lithium ion battery, because the nano-fiber non-woven fabric separator is difficult to be manipulated in the present preparation technology of the lithium ion battery due to its poor mechanical strength. In addition, the nano-fiber non-woven fabric separator, which has micron-sized micropores, cannot prevent penetration of nano-material used as electrode material in the lithium ion battery.

Gel electrolyte, also known as gel polymer electrolyte, is a complex of polymer and electrolyte liquid. The electrolyte liquid is encapsulated in a network formed by the polymer to form a gel. Lithium ion battery using the gel polymer electrolyte is also known as gel polymer battery. Compared to the conventional liquid electrolyte, the gel polymer electrolyte has advantages such as no leakage, good flexibility, and stable physical and chemical properties. However, the gel polymer electrolyte also has some shortcomings such as poor mechanical strength and low ion conductivity. In addition, the rate performance of the gel polymer battery is much worse than that of the liquid electrolyte battery. Therefore, the application of the gel polymer electrolyte is limited to batteries used at low current rate. In the field of power batteries, the rate performance of the gel polymer electrolyte still needs to be improved. To improve the ion conductivity, ceramic nano-particles (such as TiO₂ nano-particles, SiO₂ nano-particles, Al₂O₃ nano-particles, etc.) are doped into the gel polymer electrolyte to prepare composite gel electrolyte. Rapid ion transport channels are formed at organic-inorganic interface due to complex effect and high specific surface area of the ceramic nano-particles, which improves ion conductivity of the gel polymer electrolyte, and rate performance and cycling stability of the gel polymer battery. However, ceramic nano-particles are easy to aggregate due to low Zeta-potential and high specific surface area thereof. However, the aggregated ceramic nano-particles do not have the advantages of the nano-materials. Experiments show that commercial inorganic nano-particles are difficult to disperse even after ultrasonic treatment and subsequent ball-milling, and the commercial inorganic nano-particles are easy to isolate from the gel polymer regardless of its composition and amount of the nano-particles.

### SUMMARY

A composite separator with high ion conductivity, a method for making the composite separator, and a lithium ion battery using the composite separator are provided.

The composite separator comprises a non-woven fabric-polymer composite separator substrate and a composite gel combined with the non-woven fabric-polymer composite separator substrate. The composite gel comprises a gel polymer and a nano-barium sulfate whose surface is modified with a lithium carboxylate group. The nano-barium sulfate is dispersed to the gel polymer. The non-woven fabric-polymer composite separator substrate comprises a non-woven fabric and a soluble heat-resistant polymer.

The method for making the composite separator comprises: adding a lithium carboxylate solution formed by dissolving lithium carboxylate in a first organic solvent to a soluble barium salt aqueous solution, and mixing the lithium carboxylate solution with the soluble barium salt aqueous solution to form a first solution; providing a soluble sulfate aqueous solution with a pH value in a range from about 8 to about 10, and adding the soluble sulfate aqueous solution to the first solution to react to produce a precipitate; separating the precipitate, washing the precipitate by water, and drying the precipitate to obtain the nano-barium sulfate whose surface is modified with a lithium carboxylate group; dispersing the nano-barium sulfate whose surface is modified with the lithium carboxylate group to a second organic solvent to form a dispersion liquid; adding a gel polymer to the dispersion liquid, and mixing the gel polymer with the dispersion liquid uniformly to obtain a composite gel; making the non-woven fabric-polymer composite separator substrate by the following steps of: (1) providing a polymer solution formed by dissolving the soluble heat-resistant polymer in a third organic solvent; (2) immersing the non-woven fabric in the polymer solution; and (3) taking the non-woven fabric out, thereafter drying the non-woven fabric; and combining the composite gel with the non-woven fabric-polymer composite separator substrate.

The lithium ion battery comprises a cathode, an anode, and a gel polymer electrolyte membrane located between the cathode and the anode. The gel polymer electrolyte membrane comprises the composite separator and a non-aqueous electrolyte liquid permeating into the composite separator.

In the present disclosure, the nano-barium sulfate whose surface is modified with the lithium carboxylate group with high dispersibility is prepared. Due to the lithium carboxylate group, the nano-barium sulfate is easy to be dispersed uniformly, the Zeta-potential of the nano-barium sulfate is changed, and the surface energy of the nano-barium sulfate is decreased. As doping-particles mix with the gel polymer, the nano-barium sulfate can be dispersed uniformly to the gel polymer to obtain the composite gel. The lithium carboxylate group can facilitate the lithium ion transport and increase the ion conductivity, thereby improving the rate performance of the lithium ion battery. The composite gel is filled in a plurality of micropores of the non-woven fabric, and then the composite separator is obtained by a phase inversion method. Due to the nano-barium sulfate, the ion conductivity of the composite separator is increased. Simultaneously, the advantages of heat-resistance of the non-woven fabric, and non-leakage and non-inflammability of the gel electrolyte are present to the composite separator. In addition, by combining nano-fibers of the non-woven fabric and the gel polymer, the composite separator is impenetrable to the electrode material, and the mechanical strength of the composite separator is increased.

### BRIEF DESCRIPTION OF THE DRAWINGS

Implementations are described by way of example only with reference to the attached figures.

FIG. 1 shows a scanning electron microscope photo of Example 1 of a nano-barium sulfate.

FIG. 2 shows a scanning electron microscope photo of Example 4 of a surface of a composite separator.

FIG. 3 shows a scanning electron microscope photo of Example 4 of a cross section of the composite separator.

FIG. 4 is a graph showing cycling performances at different current rates of Example 4, Comparative Example 1, and Comparative Example 3 of lithium ion batteries.

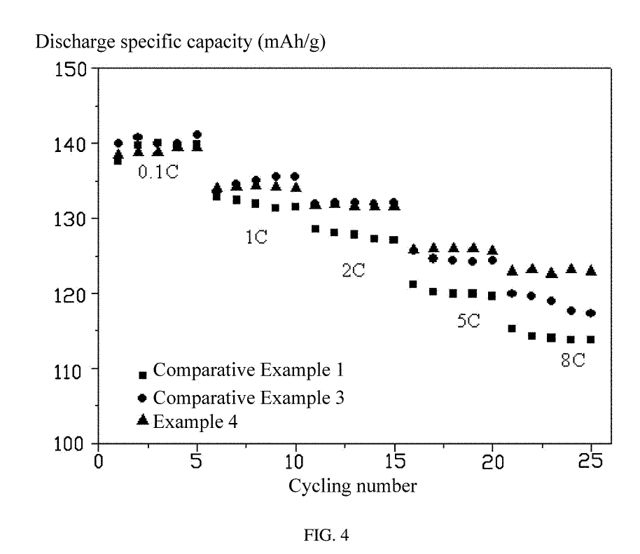

### DETAILED DESCRIPTION

A detailed description with the above drawings is made to further illustrate the present disclosure.

One embodiment of a method for making a composite separator comprises the following steps of:

S1, making a nano-barium sulfate whose surface is modified with a lithium carboxylate group;

S2, making a composite gel by combining the nano-barium sulfate whose surface is modified with the lithium carboxylate group with a gel polymer;

S3, making a non-woven fabric-polymer composite separator substrate; and

S4, combining the composite gel and the non-woven fabric-polymer composite separator substrate.

The step S1 can further comprise the following steps of:

S11, providing a lithium carboxylate solution formed by dissolving lithium carboxylate in a first organic solvent, and mixing the lithium carboxylate solution with a soluble barium salt aqueous solution to form a first solution;

S12, providing a soluble sulfate aqueous solution with a pH value in a range from about 8 to about 10, and adding the soluble sulfate aqueous solution to the first solution to react to obtain a precipitate; and

S13, separating the precipitate, washing the precipitate by water, and drying the precipitate to obtain the nano-barium sulfate whose surface is modified with the lithium carboxylate group.

In the step S11, a stable barium-lithium carboxylate complex can be formed from the lithium carboxylate and Ba²⁺ of the soluble barium salt. In the following precipitation process of barium sulfate, the Ba²⁺ can be released slowly from the barium-lithium carboxylate complex, so that barium sulfate particles would not grow large to form the nano-barium sulfate. In addition, due to the lithium carboxylate group modified on the surface of the nano-barium sulfate in the precipitation process, the nano-barium sulfate cannot be aggregated and can be dispersed uniformly in the subsequent process. In addition, an ionophore concentration on the surface of the nano-barium sulfate is increased to facilitate the lithium ion transport in the composite separator.

The lithium carboxylate can comprise at least eight carbon atoms. The lithium carboxylate can be lithium oleate, lithium stearate, lithium dodecyl benzoate, lithium hexadecyl benzoate, or lithium polyacrylate. A mass of the lithium carboxylate can be in a range from about 1% to about 5% of a mass of the nano-barium sulfate theoretically obtained in the subsequent process.

The first organic solvent is capable of dissolving the lithium carboxylate, and making a plurality of mesopores formed inside each barium sulfate particle. The first organic solvent can be a water-soluble polar solvent, such as methanol, ethanol, isopropanol, acetone, N,N-dimethylformamide (DMF), N,N-dimethylacetamide (DMAc), or N-Methyl pyrrolidone (DMP). In one embodiment, the first organic solvent can be alcohols solvent such as ethanol, methanol, or isopropanol. A volume ratio of the first organic solvent to the soluble barium salt aqueous solution can be in a range from about 1:1 to about 2:1, such as about 1:1.

A concentration of the soluble barium salt aqueous solution can be in a range from about 0.1 mol/L to about 0.5 mol/L. The soluble barium salt can be barium chloride, barium nitrate, barium sulfide, or the other commonly used soluble barium salt.

In the step S12, the soluble sulfate aqueous solution can be added slowly to the first solution, during which the nano-sized barium sulfate particles can be formed by SO₄²⁻ of the soluble sulfate and Ba²⁺ released slowly in the first solution, the lithium carboxylate group can be modified on the surface of the nano-barium sulfate, and a plurality of mesopores can be formed inside each barium sulfate particle. The soluble sulfate can be sodium sulfate, potassium sulfate, ammonium sulfate, aluminum sulfate, or the other commonly used soluble sulfate. A concentration of the soluble sulfate aqueous solution can be in a range from about 0.1 mol/L to about 0.5 mol/L. A molar ratio of the soluble sulfate to the soluble barium salt can be about 1:1. The pH value of the soluble sulfate aqueous solution can be regulated in a range from about 8 to about 10 by an alkaline solution of ammonium hydroxide, sodium hydroxide, potassium hydroxide, etc.

In the step S13, the precipitate can be separated from the production fluid by centrifugation, washed by water for three or four times, and vacuum dried to obtain the nano-barium sulfate whose surface is modified with lithium carboxylate group. A particle size of the nano-barium sulfate can be in a range from about 30 nm to about 500 nm. A specific surface area of the nano-barium sulfate can be in a range from about 5 m²/g to about 20 m²/g. The plurality of mesopores can be formed inside each barium sulfate particle. A pore diameter of each mesopore can be in a range from about 6 nm to 10 nm.

From the step S11 to the step S13, a temperature in the processes can be in a range from about 15° C. to about 45° C.

In the step S2, a method for making the composite gel can comprise the following steps of:

S21, dispersing the nano-barium sulfate whose surface is modified with lithium carboxylate group to a second organic solvent to form a dispersion liquid; and

S22, adding a gel polymer to the dispersion liquid and mixing uniformly to obtain the composite gel.

In the S21, the nano-barium sulfate whose surface is modified with lithium carboxylate group can be added to the second organic solvent and dispersed by mechanical stirring or ultrasonic vibration. A time of the mechanical stirring or the ultrasonic vibration can be varied according to needs, such as in a range from about 0.5 hour to about 2 hours.

In the step S22, the gel polymer can be added gradually to the dispersion liquid while stirring. The gel polymer and the dispersion liquid can be stirred continuously until mixed uniformly, so that the nano-barium sulfate whose surface is modified with lithium carboxylate group can be dispersed uniformly to the gel polymer.

The second organic solvent is capable of dispersing the nano-barium sulfate whose surface is modified with lithium carboxylate group and the gel polymer. The second organic solvent can be a polar organic solvent, such as at least one of NMP, DMF, DMAc, and acetone. The gel polymer can be a gel polymer commonly used in a gel electrolyte lithium ion battery, such as at least one of polymethylmethacrylate (PMMA), copolymer of polyvinylidene fluoride and polyhexafluoropropylene (PVDF-HFP), polyacrylonitrile (PAN), and polyoxyethylene (PEO).

In the composite gel, a mass ratio of the nano-barium sulfate to the gel polymer can be in a range from about 2:100 to 30:100. A solid content of the composite gel can be in a range from about 10 wt % to about 30 wt %. The solid content of the composite gel can be calculated by (m1+m2)/m3, wherein m1 is a mass of the gel polymer, m2 is a mass of the nano-barium sulfate, and m3 is a mass of the second organic solvent.

In the step S3, a method for making the non-woven fabric-polymer composite separator substrate can comprise the following steps of:

S31, providing a polymer solution formed by dissolving a soluble heat-resistant polymer in a third organic solvent;

S32, immersing a non-woven fabric commonly used in a separator of the lithium ion battery in the polymer solution; and

S33, taking the non-woven fabric out from the polymer solution and drying the non-woven fabric.

The soluble heat-resistant polymer can be a polymer with a glass-transition temperature higher than 150° C., such as soluble polyether-ether-ketones, soluble polyether sulfones, soluble polyamides, soluble polyimides, and soluble polyarylethers. The third organic solvent to dissolve the soluble heat-resistant polymer can be acetone, acetonitrile, DMF, DMAc, NMP, dimethyl sulfoxide (DMSO), and combinations thereof. A concentration of the polymer solution can be in a range from about 0.5 wt % to about 3 wt %.

The non-woven fabric can be a nano-fiber non-woven fabric commonly used in the separator of the lithium ion battery. A heat-resistance temperature of the non-woven fabric can be higher than 150° C. A thickness of the non-woven fabric can be in a range from about 15 μm to about 60 μm. The non-woven fabric can be polyimide nano-fiber non-woven fabric, polyethylene terephthalate (PET) nano-fiber non-woven fabric, cellulose nano-fiber non-woven fabric, aramid nano-fiber non-woven fabric, glass fiber non-woven fabric, nylon nano-fiber non-woven fabric, polyacrylonitrile nano-fiber non-woven fabric, or polyvinylidenefluoride (PVDF) nano-fiber non-woven fabric.

The non-woven fabric can be immersed in the polymer solution for about 1 minute to 5 minutes, thereafter taking out and drying at a temperature range from about 50° C. to about 80° C. to remove the third organic solvent.

The non-woven fabric-polymer composite separator substrate can comprise the following two components: 1) the non-woven fabric; and 2) the soluble heat-resistant polymer. The nano-fibers of the non-woven fabric are only physically combined with each other by a weak bindingforce. The polymer solution can have a low concentration. By immersing the non-woven fabric in the polymer solution and taking the non-woven fabric out from the polymer solution, a thin layer of the polymer solution can be formed on a surface of each nano-fiber. The soluble heat-resistant polymer can be independently coated on the surface of each nano-fiber after drying, so that a plurality of micropores of the non-woven fabric can still exist inside the non-woven fabric-polymer composite separator substrate. The nano-fibers are bonded and fixed to each other by the soluble heat-resistant polymer, thereby increasing a mechanical strength of the non-woven fabric.

The S4 can further comprise the following steps of:

S41, attaching the composite gel made by the step S1 to the non-woven fabric-polymer composite separator substrate made by the step S3 to form a composite gel membrane on the non-woven fabric-polymer composite separator substrate;

S42, immersing the non-woven fabric-polymer composite separator substrate attached with the composite gel membrane to a pore-forming agent to form a plurality of pores inside the gel polymer; and

S43, drying the non-woven fabric-polymer composite separator substrate to obtain the composite separator.

In the step S41, the composite gel can be coated on one side or two sides of the non-woven fabric-polymer composite separator substrate by blade coating, dip-coating, or extrusion coating. In one embodiment, the composite gel can be coated on one side or two sides of the non-woven fabric-polymer composite separator substrate by immersing the non-woven fabric-polymer composite separator substrate in the composite gel and taking the non-woven fabric-polymer composite separator substrate out from the composite gel. The composite gel can permeate into the plurality of micropores of the non-woven fabric-polymer composite separator substrate, and form a layer structure with a thickness less than 10 μm on a surface of the non-woven fabric-polymer composite separator substrate.

In the step S42, the pore-forming agent can be poor solvent of the gel polymer, such as water, ethanol, methanol, and combinations thereof, to remove the second organic solvent contained in the composite gel membrane from the composite gel to form the plurality of pores. In one embodiment, the pore-forming agent can be ethanol aqueous (in which a concentration of the ethanol is in a range from about 2 wt % to 20 wt %). The immersing time can be in a range from about 0.5 hours to about 5 hours. After taking out from the pore-forming agent, the non-woven fabric-polymer composite separator substrate attached with the composite gel membrane can be further immersed in deionized water.

In the step S43, the non-woven fabric-polymer composite separator substrate attached with the composite gel membrane can be vacuum dried at a temperature range from about 40° C. to about 90° C. for about 4 hours to about 10 hours.

One embodiment of a composite separator comprises anon-woven fabric-polymer composite separator substrate and a composite gel combined with the non-woven fabric-polymer composite separator substrate. The composite gel can be membranous and be attached on the surface of the non-woven fabric-polymer composite separator substrate. A plurality of micropores can be formed inside the non-woven fabric-polymer composite separator substrate and be filled with the composite gel. The membranous composite gel formed on the surface of the non-woven fabric-polymer composite separator substrate can has a thickness range from about 2 μm to about 10 μm.

The composite gel can comprise a gel polymer and a nano-barium sulfate whose surface is modified with lithium carboxylate group dispersed to the gel polymer. A particle size of the nano-barium sulfate whose surface is modified with lithium carboxylate group can be in a range from about 30 nm to about 500 nm, such as from about 30 nm to 120 nm. The gel polymer can be a gel polymer commonly used in the gel electrolyte lithium ion battery, such as at least one of PMMA, PVDF-HFP, PAN and PEO. The nano-barium sulfate whose surface is modified with lithium carboxylate group is uniformly dispersed in the gel polymer. The plurality of micropores formed inside the non-woven fabric-polymer composite separator substrate can be filled with the composite gel comprising the nano-barium sulfate whose surface is modified with lithium carboxylate group to prevent the penetration of the electrode material. A mechanical strength of the composite gel can be increased by fibers of the non-woven fabric.

In addition, a second organic solvent soluble with the gel polymer can be contained in the composite gel. The second organic solvent can be at least one of NMP, DMF, DMAc, and acetone.

In the composite gel, a mass ratio of the nano-barium sulfate to the gel polymer can be in a range from about 2:100 to about 30:100. A solid content of the composite gel can be in a range from about 10 wt % to about 30 wt %. The solid content of the composite gel can be calculated by (m1+m2)/m3, wherein m1 is a mass of the gel polymer, m2 is a mass of the nano-barium sulfate, and m3 is a mass of the second organic solvent.

The composite separator can be immersed in a non-aqueous electrolyte to form a gel polymer electrolyte membrane when using.

The nano-barium sulfate cannot be aggregated together and can be dispersed uniformly due to the lithium carboxylate group modified on the surface of the nano-barium sulfate. Therefore, the nano-barium sulfate can be dispersed uniformly to the gel polymer to avoid isolation during preparing of the composite gel. The lithium carboxylate group modified on the surface of the nano-barium sulfate comprises lithium ions, which facilitate the lithium ion transport in the composite gel. A plurality of mesopores are formed inside each barium sulfate particle, and a plurality of interspaces are formed between barium sulfate particles of the nano-barium sulfate, thereby increasing the porosity of the composite separator, facilitating the penetration of the electrolyte liquid, and improving the wettability of the composite separator.

One embodiment of a lithium ion battery comprised a cathode, an anode, and a gel polymer electrolyte membrane located between the cathode and the anode. The gel polymer electrolyte membrane can comprise the composite separator and a non-aqueous electrolyte liquid infiltrating into the composite separator.

The non-aqueous electrolyte liquid can comprise a solvent and a lithium salt dissolving in the solvent. The solvent can be selected from cyclic carbonates, chain carbonates, cyclic ethers, chain ethers, nitriles, amides and combinations thereof, such as ethylene carbonate, propylene carbonate, diethyl carbonate, dimethyl carbonate, ethyl methyl carbonate, methyl acetate, ethyl acetate, propyl acetate, methyl propionate, ethyl propionate, diethyl ether, acetonitrile, propionitrile, anisole, butyrate, adiponitrile, glutaronitrile, gamma-butyrolactone, gamma-valerolactone, tetrahydrofuran, 1,2-dimethoxyethane, dimethylformamide, and combinations thereof. The lithium salt can be selected from lithium chloride (LiCl), lithium hexafluoro phosphate (LiPF₆), lithium tetrafluoro borate (LiBF₄), lithium methane sulfonate (LiCH₃SO₃), lithium trifluoro methane sulfonate (LiCF₃SO₃), lithium hexafluoro arsenate (LiAsF₆), lithium hexafluoro antimonate (LiSbF₆), lithium perchlorate (LiClO₄), lithium bisoxalatoborate (LiBOB), and combinations thereof.

The cathode can further comprise a cathode current collector and a cathode material layer. The cathode current collector is configured to support the cathode material layer and conduct electricity. A shape of the cathode current collector can be foil or mesh. A material of the cathode current collector can be selected from aluminum, titanium, or stainless steel. The cathode material layer can be located on at least one surface of the cathode current collector. The cathode material layer can comprise a cathode active material, and furthermore, a conducting agent and a binder. The conducting agent and the binder can be mixed uniformly with the cathode active material. The cathode active material can be lithium iron phosphate, spinel lithium manganate, lithium cobalt oxide, or lithium nickel oxide.

The anode can further comprise an anode current collector and an anode material layer. The anode current collector is configured to support the anode material layer and conduct electricity. A shape of the anode current collector can be foil or mesh. A material of the anode current collector can be selected from aluminum, titanium, or stainless steel. The anode material layer can be located at least one surface of the anode current collector. The anode material layer can comprise an anode active material, furthermore, a conducting agent and a binder. The conducting agent and the binder can be mixed uniformly with the anode active material. The anode active material can be graphite, acetylene black, mesocarbon microbead, carbon fibers, carbon nanotubes, or cracked carbon.

In the present disclosure, the nano-fiber non-woven fabric and the gel electrolyte are combined, and the nano-barium sulfate whose surface is modified with lithium carboxylate group is dispersed in the gel polymer. The disadvantages of the two materials are overcome. For example, the gel polymer filled in the plurality of micropores of the nano-fiber non-woven fabric can prevent electrode material from penetrating, and the fibers of the non-woven fabric can increase the mechanical strength of the gel polymer. The advantages of the two materials, such as thermal dimensional stability of the non-woven fabric and electrolyte liquid leakage resistance of the gel, are combined in the composite separator. In addition, the nano-barium sulfate whose surface is modified with lithium carboxylate group can provide better ion conductivity for the gel electrolyte.

### Examples I Preparation of the Nano-Barium Sulfate

### Example 1

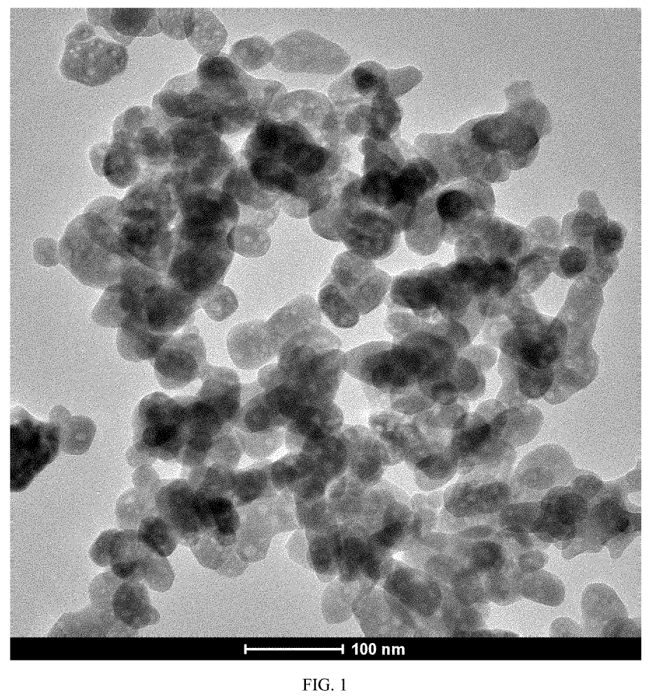

0.01 g of lithium oleate is dissolved in 50 ml of absolute methanol to form a lithium oleate solution. The lithium oleate solution is added to 50 ml, 0.5 mol/L of barium chloride solution, and mixed uniformly for 20 minutes to 30 minutes to obtain a mixture solution. 50 ml, 0.5 mol/L of sodium sulfate solution is added to the mixture solution slowly after that the pH value of the sodium sulfate solution is regulated to 8-9 by ammonium hydroxide solution. The precipitate is separated by centrifugation, washed with water for three times, and vacuum dried in a drying oven at 80° C. to obtain the nano-barium sulfate whose surface is modified with the lithium carboxylate group. Referring to FIG. 1, the nano-barium sulfate has a small particle size in a range from about 30 nm to about 50 nm. A plurality of interspaces are formed between the barium sulfate particles of the nano-barium sulfate. A plurality of mesopores with a pore diameter in a range from about 6 nm to about 10 nm are formed inside each barium sulfate particle. A specific surface area of the nano-barium sulfate is about 19.9 m²/g.

### Example 2

0.02 g of lithium stearate is dissolved in 100 ml of N,N-dimethylformamide to obtain a lithium stearate solution. The lithium stearate solution is added to 100 ml, 0.5 mol/L of barium nitrate solution, and mixed uniformly for 20 minutes to 30 minutes to obtain a mixture solution. 100 ml, 0.5 mol/L of potassium sulfate solution is added to the mixture solution slowly after that the pH value of the potassium sulfate solution is regulated to 8-9 by sodium hydroxide solution. The precipitate is separated by centrifugation, washed by water for three times or four times, and vacuum dried in a drying oven at 80° C. to obtain the nano-barium sulfate whose surface is modified with lithium carboxylate group. The nano-barium sulfate has a particle size in a range from about 50 nm to about 80 nm.

### Example 3

0.03 g of lithium polyacrylate is dissolved in 150 ml of acetone to obtain a lithium polyacrylate solution. The lithium polyacrylate solution is added to 150 ml, 0.5 mol/L of barium chloride solution, and mixed uniformly for 20 minutes to 30 minutes to obtain a mixture solution. 150 ml, 0.5 mol/L of ammonium sulfate solution is added to the mixture solution slowly after that the pH value of the ammonium sulfate solution is regulated to 8-9 by potassium hydroxide solution. The precipitate is separated by centrifugation, washed by water for three times, and vacuum dried in a drying oven at 80° C. to obtain the nano-barium sulfate whose surface is modified with lithium carboxylate group. The nano-barium sulfate has a particle size in a range from about 80 nm to about 120 nm.

### Examples II Preparation of Composite Gel and Gel Polymer Electrolyte Membrane

### Example 4

1 g of the nano-barium sulfate whose surface is modified with lithium carboxylate group prepared by Example 1 are added to 30 ml of N-methyl-2-pyrrolidone and stirred for 3 hours to obtain a uniformly dispersion liquid. 5 g of gel polymer PVDF-HFP is added to the dispersion liquid and stirred for 4 hours to obtain the composite gel. The PI nano-fiber non-woven fabric prepared by electrospinning method are immersed in a DMFC solution dissolving 1 wt % of soluble polyether-ether-ketone for 5 minutes, taken out from the DMFC solution, and dried in an oven at 60° C. for 5 hours to move the solvent, thereby obtaining a PI non-woven-soluble polyether-ether-ketone composite separator substrate. The composite separator substrate is immersed in the composite gel for 5 minutes so that the composite gel is adsorbed in the plurality of micropores of the composite separator substrate. And then the composite separator substrate is taken out from the composite gel, immersed in 10% of ethanol aqueous solution for 1 hour, taken out from the ethanol aqueous solution, and dried in a vacuum oven at 60° C. for 6 hours, thereby obtaining the composite separator.

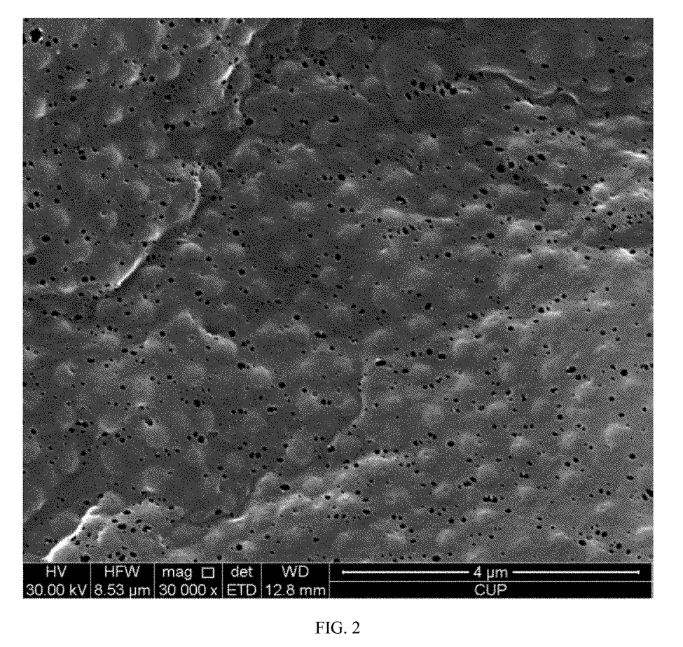

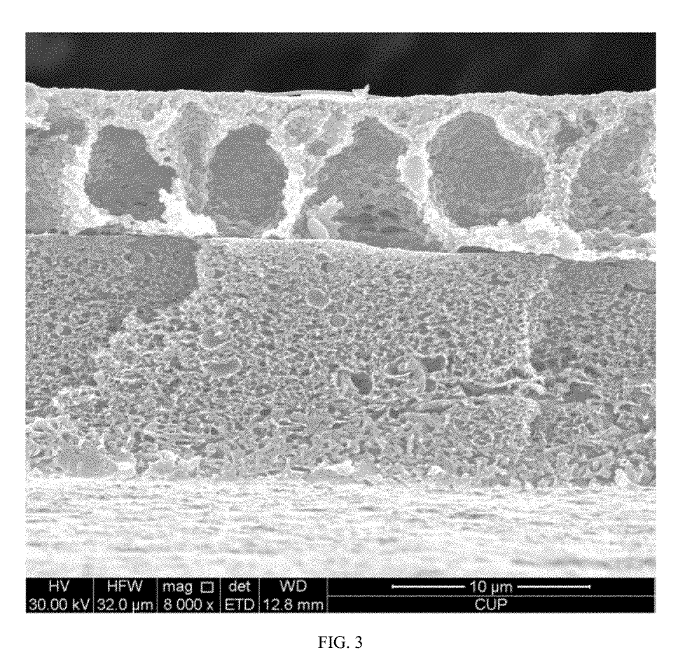

Referring to FIG. 2, a plurality of micropores are formed on the surface of the composite separator. The composite gel is coated on the surface of the composite separator uniformly. The nano-barium sulfate cannot be seen from FIG. 2. Referring to FIG. 3, a thickness of the composite gel layer formed on the surface of the composite separator substrate is less than 10 μm. The composite separator is immersed in an electrolyte liquid for 5 minutes and adsorbs the electrolyte liquid to form the gel polymer electrolyte membrane. The electrolyte liquid comprises 1.0 M of LiPF₆ and a mixture solvent formed by EC and DEC with a volume ratio of 1:1. A thickness and a liquid absorption rate of the composite separator, and an ion conductivity and a thermal contraction of the gel polymer electrolyte membrane are tested and listed in table 1.

### Example 5

1 g of the nano-barium sulfate whose surface is modified with lithium carboxylate group prepared by Example 1 are added to 30 ml of N-methyl-2-pyrrolidone and stirred for 3 hours to obtain a uniformly dispersion liquid. 5 g of gel polymer PMMA is added to the dispersion liquid and stirred for 4 hours to obtain the composite gel. The PET nano-fiber non-woven fabric prepared by electrospinning method is immersed in a DMFC solution dissolving 1 wt % of soluble polyimide for 5 minutes, taken out from the DMFC solution, and dried in an oven at 60° C. for 5 hours to move the solvent, thereby obtaining a PET non-woven-soluble polyimide composite separator substrate. The composite separator substrate is immersed in the composite gel for 5 minutes so that the composite gel is adsorbed in the micropores of the composite separator substrate, taken out from the composite gel, immersed in 10% of ethanol aqueous solution for 1 hours, taken out from the ethanol aqueous solution, and dried in a vacuum oven at 60° C. for 6 hours, thereby obtaining the composite separator.

A gel polymer electrolyte membrane is made by the same method as Example 4. A thickness and a liquid absorption rate of the composite separator, and an ion conductivity and a thermal contraction of the gel polymer electrolyte membrane are tested and listed in table 1.

### Comparative Example 1

5 g of PVDF-HEF is added to and dissolved in 30 ml of N-Methyl pyrrolidone by stirring to obtain a PVDF-HEF gel liquid. Celgard 2300 polypropylene separator is immersed in the PVDF-HEF gel liquid, and taken out after 5 minutes, so that the PVDF-HEF gel liquid is adsorbed in the micropores of the polypropylene separator. Then the polypropylene separator is immersed in a 10% of ethanol aqueous solution, taken out after 1 hour, and dried in a vacuum oven at 60° C. for 6 hours, thereby obtaining the composite separator.

A gel polymer electrolyte membrane is made by the same method as Example 4. A thickness and a liquid absorption rate of the composite separator, and an ion conductivity and a thermal contraction of the gel polymer electrolyte membrane are tested and listed in table 1.

### Comparative Example 2

5 g of PVDF-HEF is added to and dissolving in 30 ml of N-Methyl pyrrolidone by stirring to obtain a PVDF-HEF gel liquid. PI nano-fiber non-woven fabric prepared by electrospinning method is immersed in a DMFC solution dissolving 1 wt % of soluble polyether-ether-ketone for 5 minutes, taken out from the DMFC solution, and dried in an oven at 60° C. for 5 hours to move the solvent, thereby obtaining a PI non-woven fabric-soluble polyether-ether-ketone composite separator substrate. The composite separator substrate is immersed in the PVDF-HEF gel liquid, and taken out after 5 minutes, so that the PVDF-HEF gel liquid is adsorbed in the micropores of the composite separator substrate. Then the composite separator substrate is immersed in a 10% of ethanol aqueous solution, taken out after 1 hour, and dried in a vacuum oven at 60° C. for 6 hours, thereby obtaining the composite separator.

A gel polymer electrolyte membrane is made by the same method as Example 4. A thickness and a liquid absorption rate of the composite separator, and an ion conductivity and a thermal contraction of the gel polymer electrolyte membrane are tested and listed in table 1.

### Comparative Example 3

1 g of commercial nano-barium sulfate are added and dispersed to 30 ml of N-Methyl pyrrolidone by stirring for 3 hours to obtain a uniformly dispersion liquid. 5 g of PVDF-HEF is added to the dispersion liquid, and stirred for 4 hours to obtain a composite gel liquid. PI nano-fiber non-woven fabric prepared by electrospinning method is immersed in a DMFC solution dissolving 1 wt % of soluble polyether-ether-ketone for 5 minutes, taken out from the DMFC solution, and dried in an oven at 60° C. for 5 hours to move the solvent, thereby obtaining a PI non-woven fabric-soluble polyether-ether-ketone composite separator substrate. The composite separator substrate is immersed in the composite gel liquid, and taken out after 5 minutes, so that the composite gel liquid is adsorbed in the micropores of the composite separator substrate. Then the composite separator substrate is immersed in a 10% of ethanol aqueous solution, taken out after 1 hour, and dried in a vacuum oven at 60° C. for 6 hours, thereby obtaining the composite separator.

TABLE 1

| | Compar- | Compar- | Compar- | | |
|---|---|---|---|---|---|
| | ative | ative | ative | Example | Example |
| | Example 1 | Example 2 | Example 3 | 4 | 5 |
| Thickness | 20 | 31 | 33 | 33 | 34 |
| (μm) | | | | | |
| Liquid | 180 | 260 | 270 | 320 | 310 |
| adsorption | | | | | |
| rate | | | | | |
| (wt %) | | | | | |
| Ion | 0.36 | 0.51 | 0.56 | 0.72 | 0.70 |
| conductivity | | | | | |
| (mS/cm) | | | | | |
| 150° C. | 45 | 0 | 0 | 0 | 0 |
| thermal | | | | | |
| contraction | | | | | |
| (%) | | | | | |
| 200° C. | melting | 0 | 0 | 0 | 0 |
| thermal | | | | | |
| contraction | | | | | |
| (%) | | | | | |

When testing the liquid adsorption rate, the composite separator is immersed in the electrolyte liquid for 12 hours, thereafter taking out and sucking the electrolyte liquid on the surface of the composite separator by a water-absorbing paper. A weight W₀ of the composite separator before the immersing and a weight W₁ of the composite separator after the immersing are measured. The liquid adsorption rate of the composite separator can be calculated by (W₁−W₀)/W₀. It can be seen from table 1 that the liquid adsorption rate of the composite separator to the electrolyte liquid and the ion conductivity of the composite separator of Example 4 and Example 5 are significantly increased compared to that of Comparative Example 1 and Comparative Example 2. Because the nano-barium sulfate added to the gel polymer is easy to absorb liquid due to its high specific surface area, and the nano-barium sulfate can also help the gel polymer has high porosity, so the liquid absorption rate of the composite separator is increased. The commercial nano-barium sulfate used in Comparative Example 3 is easy to aggregate, and cannot be dispersed uniformly in the gel polymer, so the commercial nano-barium sulfate cannot take full advantage of high specific surface to improve the liquid absorption and ion conductivity.

The composite separators of Example 4, Comparative Example 1, and Comparative Example 3 are respectively assembled with lithium cobalt oxides cathode active material and metal lithium anode to form lithium-ion batteries. The rate performances of the lithium ion batteries are tested at rates of 0.1C, 0.5C, 1C, 2C, 4C, and 8C. Specifically, the lithium ion batteries are in turn charged at 0.1C and discharged at 0.1C for five times, charged at 0.2C and discharged at 0.1C for five times, charged at 0.2C and discharged at 1C for five times, charged at 0.2C and discharged at 2C for five times, charged at 0.2C and discharged at 5C for five times, and charged at 0.2C and discharged at 8C for five times with 2.8V-4.3V of cut-off voltage. It can be seen from cycling results that the discharge capacity of the lithium ion battery of Example 4 decreases little as discharge rates increases, and has a better rate performance.

In the present disclosure, the nano-barium sulfate whose surface is modified with lithium carboxylate group with high dispersibility is prepared. Due to the lithium carboxylate group, the nano-barium sulfate is not easy to aggregate and can be dispersed uniformly to the gel polymer, Zeta-potential of the nano-barium sulfate is changed, surface energy of the nano-barium sulfate is decreased, and ionophore concentration on the surface of the nano-barium sulfate is increased. As doping-particles to mix with the gel polymer, the nano-barium sulfate can be dispersed uniformly to the gel polymer to obtain the composite gel. The lithium carboxylate group can facilitate the lithium ion transport and increase the ion conductivity, thereby improving the rate performance of the lithium ion battery.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A composite separator, comprising a non-woven fabric-polymer composite separator substrate and a composite gel combined with the non-woven fabric-polymer composite separator substrate, wherein:
the composite gel comprises a gel polymer and a nano-barium sulfate whose surface is modified with a lithium carboxylate group, and the nano-barium sulfate is dispersed in the gel polymer; and
the non-woven fabric-polymer composite separator substrate comprises a non-woven fabric and a soluble heat-resistant polymer.

2. The composite separator of claim 1, wherein the lithium carboxylate group comprises at least eight carbon atoms.

3. The composite separator of claim 1, wherein a plurality of mesopores are formed inside each barium sulfate particle of the nano-barium sulfate.

4. The composite separator of claim 1, wherein the composite gel forms a layer structure on a surface of the non-woven fabric-polymer composite separator substrate.

5. The composite separator of claim 4, wherein a thickness of the layer structure is in a range from about 2 μm to about 10 μm.

6. The composite separator of claim 1, wherein a particle size of the nano-barium sulfate is in a range from about 30 nm to about 500 nm.

7. The composite separator of claim 1, wherein the gel polymer is selected from the group consisting of polymethylmethacrylate, copolymer of vinylidene fluoride and hexafluoropropylene, polyacrylonitrile, polyoxyethylene, and combinations thereof.

8. The composite separator of claim 1, wherein a mass ratio of the nano-barium sulfate to the gel polymer is a range from about 2:100 to about 30:100.

9. The composite separator of claim 1, wherein the non-woven fabric is selected from the group consisting of polyimide nano-fiber non-woven fabric, polyethylene terephthalate nano-fiber non-woven fabric, cellulose nano-fiber non-woven fabric, aramid nano-fiber non-woven fabric, glass fiber non-woven fabric, nylon nano-fiber non-woven fabric, polyacrylonitrile nano-fiber non-woven fabric, polyvinylidenefluoride nano-fiber non-woven fabric, and combinations thereof.

10. The composite separator of claim 1, wherein a thickness of the non-woven fabric is in a range from about 15 μm to about 60 μm.

11. The composite separator of claim 1, wherein a glass-transition temperature of the soluble heat-resistant polymer is higher than 150° C.

12. The composite separator of claim 11, wherein the soluble heat-resistant polymer is selected from the group consisting of soluble polyether-ether-ketones, soluble polyether sulfones, soluble polyamides, soluble polyimides, soluble polyarylethers, and combinations thereof.

13. A method for making a composite separator, comprising:
providing a lithium carboxylate solution formed by dissolving lithium carboxylate in a first organic solvent, and mixing the lithium carboxylate solution with a soluble barium salt aqueous solution to form a first solution;
providing a soluble sulfate aqueous solution with a pH value in a range from about 8 to about 10, and adding the soluble sulfate aqueous solution to the first solution to react to obtain a precipitate;
separating, washing, and drying the precipitate to obtain a nano-barium sulfate whose surface is modified with a lithium carboxylate group;
dispersing the nano-barium sulfate to a second organic solvent to form a dispersion liquid;
adding a gel polymer to the dispersion liquid to obtain a composite gel;
making a non-woven fabric-polymer composite separator substrate by the following steps of:
dissolving a soluble heat-resistant polymer in a third organic solvent to form a polymer solution;
immersing a non-woven fabric in the polymer solution; and
taking the non-woven fabric out from the polymer solution, thereafter drying the non-woven fabric; and
combining the composite gel and the non-woven fabric-polymer composite separator substrate.

14. The method of claim 13, wherein a volume ratio of the first organic solvent and the soluble barium salt aqueous solution is in a range from about 1:1 to about 2:1.

15. The method of claim 13, wherein the first organic solvent is a water-soluble polar organic solvent.

16. The method of claim 13, wherein the lithium carboxylate is selected from the group consisting of lithium oleate, lithium stearate, lithium dodecyl benzoate, lithium hexadecyl benzoate, lithium polyacrylate, and combinations thereof.

17. The method of claim 13, wherein a mass of the lithium carboxylate is in a range from about 1% to about 5% of a mass of the nano-barium sulfate.

18. The method of claim 10, wherein a concentration of the polymer solution is in a range from about 0.5 wt % to about 3 wt %.

19. The method of claim 13, wherein the combining the composite gel and the non-woven fabric-polymer composite separator substrate comprises the following steps of:
attaching the composite gel on the non-woven fabric-polymer composite separator substrate to form a composite gel membrane on the non-woven fabric-polymer composite separator substrate;
immersing the non-woven fabric-polymer composite separator substrate attached with the composite gel membrane in a pore-forming agent to form a plurality of pores in the gel polymer; and
drying the non-woven fabric-polymer composite separator substrate after pore-forming to obtain the composite separator.

20. A lithium ion battery, comprising a cathode, an anode, and a gel polymer electrolyte membrane located between the cathode and the anode, wherein
the gel polymer electrolyte membrane comprises a composite separator and a non-aqueous electrolyte liquid permeating into the composite separator;
the composite separator comprises a non-woven fabric-polymer composite separator substrate and a composite gel combined with the non-woven fabric-polymer composite separator substrate;
the composite gel comprises a gel polymer and a nano-barium sulfate whose surface is modified with a lithium carboxylate group, and the nano-barium sulfate is dispersed in the gel polymer; and
the non-woven fabric-polymer composite separator substrate comprises a non-woven fabric and a soluble heat-resistant polymer.
